(19) United States
(12) Patent Application Publication
(10) Pub. No.: US 2008/0157958 A1
(43) Pub. Date: Jul. 3, 2008

(54) Anti-theft device with trigger

(75) Inventors: Chia-Yu Lin, Taipei (TW); Chun-Hsiung Lin, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/646,342

(22) Filed: Dec. 28, 2006

(51) Int. Cl. G08B 1/08

(52) U.S. Cl. 340/539.11

(57) ABSTRACT

An anti-theft device with a trigger applied in a portable electronic device is provided, which has a trigger electrically connected with a trigger unit selectively. When the trigger is separated from the trigger unit, a sensing element begins to carry out the sensing operation, and the portable electronic device is put into a power saving mode. When the sensing element senses that the electronic device has been moved, it transmits a signal to a processor. Meanwhile, the portable electronic device and an alarm unit of the trigger will be enabled simultaneously, making a sound to warn the user.

### BACKGROUND OF THE INVENTION

1. Field of Invention

The present invention relates to an anti-theft device, and more particularly, to an anti-theft device with a trigger, which is applied in a portable electronic device.

2. Related Art

With the continuous and flourishing development of technology and information, computer equipment has become indispensable in work and daily life. The manufacturing of 3C (Computer, Communication, Consumer Electronics) products is developing towards miniaturization. Portable electronic devices commercially available in the market are becoming smaller and smaller in size. For a user who often needs to move around or to work in a public place for a long time, portable electronic products are easier to be taken along and placed, greatly improving convenience of use. However, since the portable electronic product is small in size and is easy to be taken away, if the user has to leave, for example, for the washroom, in such a situation that it is inconvenient and unnecessary to take it along, the expensive and easily fetchable portable electronic product would easily become the object of thieves, and the user is also worried about the security of the computer that is out of his/her sight.

In order to solve the problem of notebooks being easily stolen, many computer manufacturers have designed various notebook guard locks, wherein an object that is not easy to be moved is utilized to lock together with the notebook by a guard lock. However, the computer guard lock may only prevent the computer from being stolen, and it cannot make an alarm to warn the owner.

In order to provide the function of making an alarm to warn the user, a U.S. Pat. No. 575,214 “A Computer Anti-theft Alarming Device” issued in Taiwan Patent Gazette on Feb. 1^{st}, 2004, an alarm and a sensor are electrically connected with the processor of a computer. When the sensor senses that the computer has been moved, it transmits a sensing signal to the processor, which in turn transmits an alarming signal to the alarm, so that it will make a sound to warn the user. In another U.S. Pat. No. 313,292 “A Safe Anti-theft device for Portable Computer” issued in Taiwan Patent Gazette on Aug. 11^{th}, 1997, a remote controller may be used to remotely control the on or off of an anti-theft device.

The remote controller and the notebook are two independent individuals with the same function, resulting in a waste of manufacturing costs, and there is no suitable place to accommodate the remote controller, thus it easily gets lost. Also, the anti-theft device operates only in the booted state of a computer, because signals cannot pass through the processor to enable the anti-theft device when the computer is powered off. If it is just the moment when the user is leaving, and the computer equipment cannot enable the anti-theft device due to low battery, a thief may easily take the computer away without being noticed. If the user himself/herself starts the anti-theft device and imprudently moves the computer, the loud alarm sound will be made in public, disturbing the user and other people around.

In addition, the alarm function is only limited to the notebook itself, and the remote controller only provides the function of remote controlling without the function of alarming. If the user happens to neglect the alarm sound from the computer, the warning effect is greatly reduced.

### SUMMARY OF THE INVENTION

In view of the above problems, the present invention provides an anti-theft device with a trigger, thereby improving the limitations or disadvantages of the prior art.

The present invention has a trigger, which is electrically connected with a trigger unit selectively. When the trigger is separated from the trigger unit, a sensing element electrically connected with the trigger unit is enabled. When the trigger is not in use, it can be combined with the electronic device, so that the accommodating problem of the remote controller is solved.

When the sensing element senses that the electronic device has been moved, it immediately transmits a signal to the processor, so that the alarm unit of the electronic device makes an alarm, and meanwhile the trigger is also enabled to make an alarm by a wireless transmission module, so that the user will be more clearly warned. The trigger can be a remote controller for remotely controlling the portable electronic device.

It is an advantage of the present invention that the trigger can combined with the electronic device, so that the accommodating problem of the remote controller is solved, and when the electronic device has been moved, the alarm unit and the trigger make an alarm simultaneously, so as to remind the user be attention.

In addition, the trigger unit is further electrically connected with the processor. When the trigger is separated from the trigger unit, the sensing element is enabled, and meanwhile the trigger unit transmits a signal to the processor, so that the portable electronic device enters a power saving mode. When the trigger is coupled with the trigger unit, the sensing element is disabled at once, and the portable electronic device is meanwhile woken up from the power saving mode.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a schematic view of the present invention;

FIG. 2 is a block diagram of the present invention;

FIG. 3 is a control flow chart of the present invention;

FIG. 4 is a block diagram of another embodiment of the present invention; and

FIG. 5 is a control flow chart of another embodiment of the present invention.

### DETAILED DESCRIPTION OF THE INVENTION

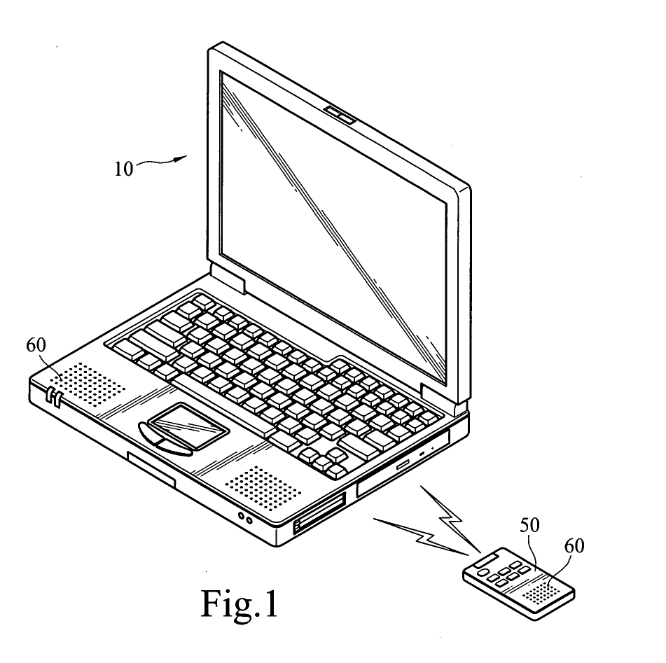

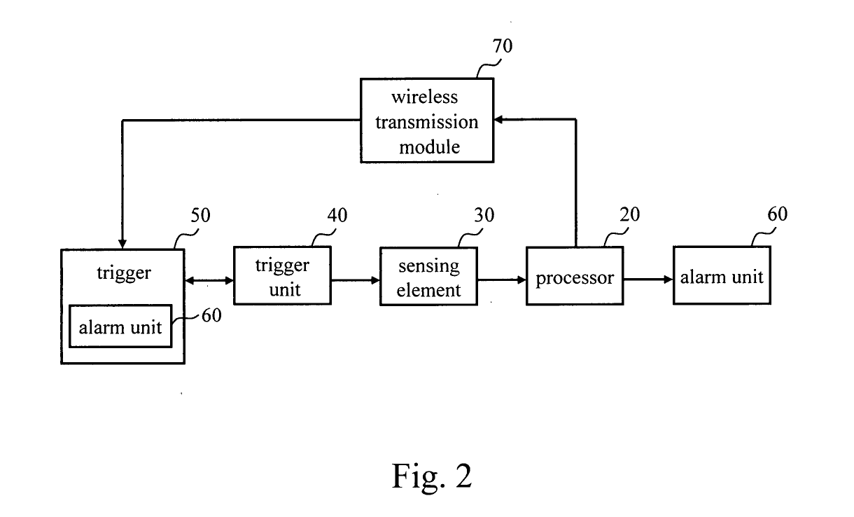

Please refer to FIGS. 1 and 2. FIG. 1 is a schematic view of the present invention. FIG. 2 is a block diagram of the present invention. As shown in FIGS. 1 and 2, an anti-theft device of the present invention applied in a portable electronic device 10 includes a processor 20 that is electrically connected with an alarm unit 60, a sensing element 30 electrically connected with the processor 20, a trigger unit 40 electrically connected with the sensing element 30, and a trigger 50 electrically connected with the trigger unit 40 selectively. When the trigger 50 is separated from the trigger unit 40, the sensing element 30 begins to carry out the sensing operation. When the trigger 50 is coupled with the trigger unit 40, the sensing operation of the sensing element 30 is disabled.

The trigger 50 is provided with an alarm unit 60. When the sensing element 30 transmits a signal to the processor 20, not only will the alarm unit 60 of the portable electronic device 10 make an alarm, but also the signal is transmitted by a wireless transmission module 70, so that the alarm unit 60 of the trigger 50 makes an alarm at the same time.

The sensing element 30 can be one of a shock sensor and a level sensor. Further, the trigger 50 can be a remote controller to remotely control the portable electronic device 10.

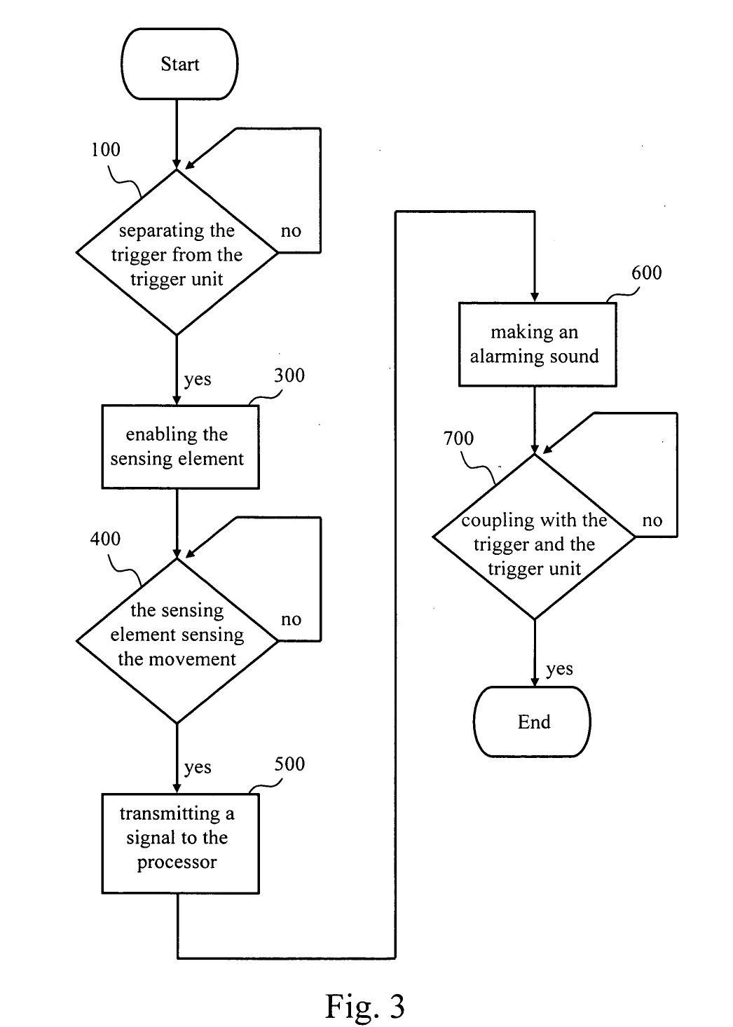

Please refer to FIG. 3 of a control flow chart of the present invention. As shown in FIG. 3, the trigger 50 is separated from the trigger unit 40 (step 100), and then the sensing element 30 is enabled to carry out the sensing operation (step 300). If not, the operation of the sensing element 30 is disabled. If the sensing element 30 senses that the portable electronic device 10 has been moved (step 400), it transmits a signal to the processor 20 (step 500), so that the alarm unit 60 will make a sound (step 600). If not, the sensing element 30 continues the sensing operation. If the trigger 50 is coupled with the trigger unit 40 (step 700), the alarm will be cleared. If not, the alarm will continue.

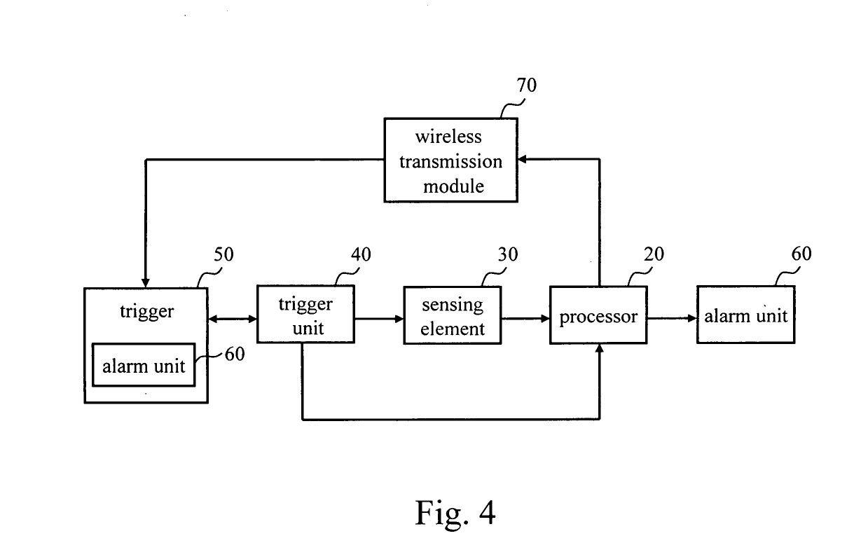

Please refer to FIG. 4 of a block diagram of a second embodiment of the present invention. As shown in FIG. 4, an anti-theft device of the second embodiment of the present invention includes a processor 20 electrically connected with an alarm unit 60, a sensing element 30 electrically connected with a processor 20, a trigger unit 40 electrically connected with the sensing element 30 and the processor 20, and a trigger 50 electrically connected with the trigger unit 40 selectively. When the trigger 50 is separated from the trigger unit 40, the sensing element 30 begins to carry out the sensing operation, and the trigger unit 40 transmits a signal to the processor 20, turning the portable electronic device 10 into a power saving mode. When the trigger 50 is coupled with the trigger unit 40, the sensing operation of the sensing element 30 is disabled, and the portable electronic device 10 is woken up from the power saving mode.

Furthermore, the trigger 50 is provided with an alarm unit 60 therein. When the sensing element 30 transmits a signal to the processor 20, not only will the alarm unit 60 of the portable electronic device 10 make an alarm, but also the signal will be transmitted by a wireless transmission module 70, so that the alarm unit 60 of the trigger 50 makes an alarm at the same time. The sensing element 30 can be one of a shock sensor and a level sensor. Further, the trigger 50 can be a remote controller to remotely control the portable electronic device 10.

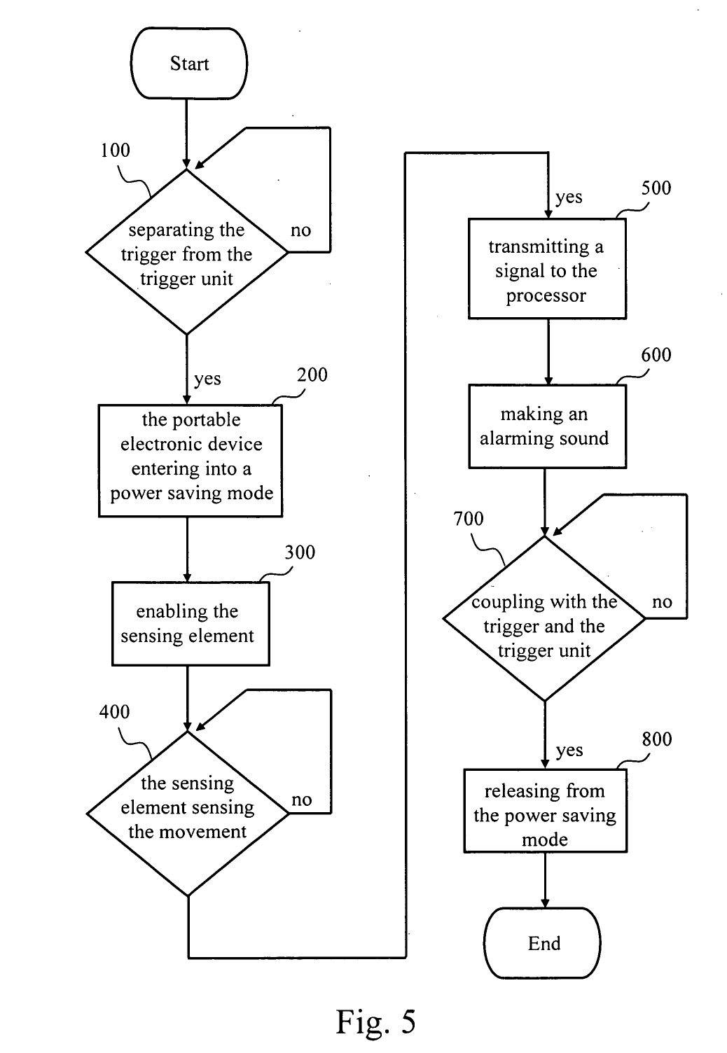

Please refer to FIG. 5 of a control flow chart according to the second embodiment of the present invention. The trigger 50 is separated from the trigger unit 40 (step 100), the portable electronic device 10 will enter into a power saving mode (step 200), and meanwhile the sensing element 30 will be enabled to carry out the sensing operation (step 300). If the sensing element 30 senses that the portable electronic device 10 has been moved (step 400), it transmits a signal to the processor 20 (step 500), so that the alarm unit 60 will make a sound (step 600). If not, the sensing element 30 continues the sensing operation. If the trigger 50 is coupled with the trigger unit 40 (step 700), the portable electronic device 10 is released from the power saving mode (step 800), and meanwhile the alarm will also be cleared. If not, the alarm will continue, and the portable electronic device 10 will remain in the power saving mode.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An anti-theft device with a trigger, applied in a portable electronic device, comprising:
a processor, for receiving and transmitting signals;
a sensing element, electrically connected with the processor;
a trigger unit, electrically connected with the sensing element; and
a trigger, electrically connected with the trigger unit selectively;
wherein when the trigger is separated from the trigger unit, the sensing element is enabled; when the trigger is coupled with the trigger unit, the sensing element is disabled.

2. The anti-theft device with a trigger according to claim 1, wherein the sensing element is a shock sensor.

3. The anti-theft device with a trigger according to claim 1, wherein the sensing element is a level sensor.

4. The anti-theft device with a trigger according to claim 1, wherein the trigger has an alarm unit, and when the sensing element transmits a signal to the processor, the trigger will be enabled to make an alarm by a wireless transmission module.

5. The anti-theft device with a trigger according to claim 4, wherein the trigger is a remote controller.

6. An anti-theft device with a trigger, applied in a portable electronic device, comprising:
a processor, for receiving and transmitting signals;
a sensing element, electrically connected with the processor;
a trigger unit, electrically connected with the sensing element and the processor; and
a trigger, electrically connected with the trigger unit selectively, wherein when the trigger is separated from the trigger unit, the sensing element is enabled, and the signal is transmitted to the processor by the trigger unit, so that the portable electronic device enters into a power saving mode; when the trigger is coupled with the trigger unit, the sensing element is disabled, and the portable electronic device is woken up from the power saving mode.

7. The anti-theft device with a trigger according to claim 6, wherein the sensing element is a shock sensor.

8. The anti-theft device with a trigger according to claim 6, wherein the sensing element is a level sensor.

9. The anti-theft device with a trigger according to claim 6, wherein the trigger has an alarm unit, and when the sensing element transmits a signal to the processor, the trigger will be enabled to make an alarm by a wireless transmission module.

10. The anti-theft device with a trigger according to claim 9, wherein the trigger is a remote controller.
